(19) United States
(12) Patent Application Publication
(10) Pub. No.: US 2016/0308727 A1
(43) Pub. Date: Oct. 20, 2016

(54) METHOD FOR ESTABLISHING AND CLEARING PATHS AND FORWARDING FRAMES FOR TRANSPORT CONNECTIONS, AND NETWORK BRIDGE

(71) Applicants: UNIVERSIDAD DE ALCALÁ, Madrid (ES); INSTITUTE IMDEA NETWORKS, Madrid (ES)

(72) Inventors: Elisa ROJAS SÁNCHEZ, Madrid (ES); Guillermo IBÁÑEZ FERNÁNDEZ, Madrid (ES); Isaías MARTÍNEZ YELMO, Madrid (ES); Arturo AZCORRA SALOÑA, Madrid (ES)

(73) Assignee: UNIVERSIDAD DE ALCALA, Madrid (ES)

(21) Appl. No.: 15/103,049

(22) PCT Filed: Dec. 10, 2014
(86) PCT No.: PCT/ES2014/070905

§ 371 Date: Jun. 9, 2016

(30) Foreign Application Priority Data
Dec. 10, 2013 (ES) P201301133

(51) Int. Cl. H04L 12/24; H04L 29/06

(52) U.S. Cl. CPC H04L 41/12; H04L 69/16

(57) ABSTRACT

Mechanisms which examine a network of transparent bridges for establishing a specific path for each new TCP connection established between two terminals. The path is initiated by the edge bridge connected to the source terminal upon receiving a TCP segment of the type SYN for establishing a TCP connection, with the segment being encapsulated inside a special path request packet which is transmitted by all the network links to the destination edge bridge. The path is confirmed by the edge bridge of the destination terminal by means of a unicast acceptance packet which transports the response SYN+ACK segment from the terminal B in an encapsulated manner, confirming both the TCP connection between terminals and the path chosen between A and B. The path is automatically cleared when a particular time passes without the connection being used or when the terminal sends a FIN segment in both directions of the connection.

### TECHNICAL FIELD

The present invention falls within the communications sector, as well as the electronic device and/or computer applications sector, which establish communications between transparent network bridges.

### BACKGROUND

Protocols are known that establish paths known as Fast-Path and ARP-Path [G. Ibanez, J. A. Carral, A. Garcia-Martinez, J. M. Arco, D. Rivera, and A. Azcorra, “Fast Path Ethernet Switching: On-demand, Efficient Transparent Bridges for Data Center and Campus Networks”, 17° IEEE Workshop on Local and Metropolitan Area Networks (LANMAN), New Jersey, USA, May 2010.] [G. Ibáñez, J. A. Carral, J. M. Arco, D. Rivera, and A. Montalvo. “ARP Path: ARP-Based, Shortest Path Bridges”. IEEE Communications Letters, 2011, pg. 770-772], which establish paths by means of the simultaneous exploration of the entire network by means of a broadcast frame such as the ARP Request and learn in the bridges crossed the source MAC addresses and their links to the port through which the first transmitted frame is received.

The aforementioned method for establishing paths operates in the following manner: In an ARP-Path bridge network, two terminals A and C establish two paths from A to C and C to A in order to communicate. These paths are learnt in the network bridges by means of transmission by all the links of a frame such as ARP Request or by means of its response, a unicast frame such as ARP Reply. The bridges link the port through which the frame is first received to the source MAC address and lock this connection, thus preventing it from being modified during a sufficient time such that the copies received in other ports of each bridge are discarded due to the fact that their source MAC address is not linked to the port through which they are received.

These paths may also be established in a known manner such as Flow-Path when an ARP Request is sent (from which the source MAC and source IP and destination in the source edge bridge are recorded) and an ARP Reply response that confirms the bidirectional and symmetrical path linked to the source and destination MAC addresses. [Elisa Rojas, Guillermo Ibanez, Diego Rivera, Juan A. Carral, “Flow-Path: An AllPath flow-based protocol”, Proceedings of the 2012 IEEE 37th Conference on Local Computer Networks (October 2012) pg. 244-247].

Likewise, protocols are known that link the source MAC address of unicast frames to an input port under certain conditions and check when they receive a unicast or multicast frame whether the port is linked or not to said frame [Minkenberg et al. US2011/0032825A1. Multipath discovery in switched Ethernet networks. Publication date, 10 Feb. 2011.] [Tanaka et al. First arrival port learning method, relay apparatus, and Computer product. U.S. Pat. No. 7,760,667 B2] [Mack-Crane et al. Media access control bridging in a mesh network. US 2010/0272108 A1]. These protocols only learn the MAC addresses, which means they cannot transmit traffic flows or user applications or processes within a single machine.

The above protocols have, among others, the drawback that all the applications being communicated between two machines, and therefore sending and receiving frames with the same destination MAC address or pair of source and destination addresses, probably share the same paths and cannot distribute the flow loads between two terminals through different paths with a fine granularity, diversifying the paths according to said flows.

It is for this reason that protocols and mechanisms that enable paths to be established in the network by means of the direct exploration thereof with multicast frames copied in the network, but more specifically, linking each path to a data flow, taking into account additional fields transported in the frames, such as transport frames (TCP, UDP or others), used in the connection between two terminals in order to identify each flow are of use.

### DESCRIPTION OF THE INVENTION

The present invention describes mechanisms that search for, establish, use and clear a specific path for each TCP connection established between two terminals and a network bridge that implements said mechanisms. The diversity of the paths is parametrizable. The invention includes a method for establishing paths in the network connected to each new flow of the TCP transport layer to establish a new TCP connection between two terminals, a method for forwarding frames through said paths and a method for clearing them when the TCP connections are closed. These methods are applied by the TCP-Path bridges that have said functionality activated, which may be configured according to the requirements of the network.

### Establishing Paths

When, as described above in the state of the art, the ARP-Path having been created between two terminals A and C, a TCP SYN segment is received in the edge bridge of the emitting (A) terminal, the segment is encapsulated in a special PathRequest frame with the source address being the MAC address of the emitting terminal A and protocol identifier (Ethertype) being the specific one assigned to TCP-Path and the source MAC address and source TCP port as well as the TCP-Path connection identifier, are linked, in a table, for the purposes of forwarding, to an expiry indicator and to the arrival time of the frame; and it is forwarded through broadcasting by all the ports except the receiving port.

In each network bridge crossed, the link is carried out in the same way and, if the receiving port of the frame from A is different to the one linked to the existing path towards A, an alternative path is registered linking said port to the tuple formed by the source MAC address A, destination MAC address C, TCP transport port used by A and TCP transport port used by C {A,C,pA,pC} (abbreviated, tuple AC), to an expiry identifier and to the arrival time of the frame. A check is carried out in each bridge as to whether the destination MAC address of the frame encapsulated within the PathRequest frame is that of a terminal connected directly to the crossed bridge. The duplicated PathRequest frames that arrive afterwards through other ports are discarded due to the fact that their source MAC address is not linked to the receiving port. Lastly, only one PathRequest packet containing the SYN segment reaches the edge bridge, connected directly to terminal C. The bridge de-encapsulates the frame and forwards it to terminal C, similarly linking an expiry identifier to the source MAC and TCP addresses and to the arrival time of the frame. Terminal C responds with a SYN+ACK segment confirming the establishment of the TCP connection. The destination edge bridge (connected to C) encapsulates the SYN+ACK segment in a Path Reply packet with source MAC address C, source MAC address A and protocol identifier (Ethertype) being that which is assigned to the TCP-Path protocol, and it is forwarded by unicast by the port linked to the tuple AC, previously linked to said port when the PathRequest packet was received. In turn, the bridge links (learns) the MAC address of C, the MAC address of A, the transport port of C and the transport port of A to the port through which it has been received, identified as the tuple [C,A,pC,pA} (abbreviated, tuple CA), linking them to the previously created expiry identifier of the tuple AC, updating the arrival time, confirming and forwarding the validity of the link. In each bridge crossed, the receiving ports are similarly linked to said tuple CA and forwarded by the linked port to the tuple AC, linked to the connection from C to terminal A, confirming and forwarding the path in the direction towards A, linking them to the previously created expiry identifier of the tuple AC, updating the arrival time, confirming and forwarding the validity of the link.

In order to increase the diversity of paths, when a bridge receives the PathRequest packet through the same port that is already linked to the generic ARP-Path for A, said bridge may link the transport path to a different port as long as it receives the duplicated PathRequest with a decreased and limited time difference with regards to the port that received it first.

The PathReply packet finally reaches, in unicast, the destination edge bridge, to which the destination terminal A is directly connected. The bridge de-encapsulates the frame containing the source SYN+ACK segment and forwards it to terminal A. Terminal A responds with a frame containing a transport segment with the ACK indicator activated, which will be forwarded as a normal segment, without being encapsulated, by the path linked to this pair of MAC addresses and to the pair of TCP ports of the connection. The successive data segments sent from terminal A to C shall be similarly routed.

The TCP-Path protocol encapsulates the transport segments that contain the activated SYN indicator (only the SYN indicator or the activated SYN and ACK indicators), and uses them to establish and confirm alternative paths to those that already exist, which were previously established by means of some of the known protocols: ARP-Path or Flow-Path. The path from A to C may previously exist or not, both the ARP-Path linked only to the MAC address A and the bidirectional Flow-Path linked to the addresses A and C, the difference lies in that TCP-Path only establishes a new path linked to the connection if there is no previous path between A and C or, if it does exist, it is different to that which is being created (i.e. the port linked to the tuple is different to the pre-existing one). As a result, the transport path TCP-Path established between A and C may partially, completely or in no way coincide with the pre-existing paths. There is only one path between A and C which is established by ARP-Path and Flow-Path, whilst TCP-Path may create as many additional paths as there are existing transport connection at any moment.

The paths are automatically refreshed, extending their validity, when flow frames linked to the path are received. This refresh may be forwards and, optionally, bidirectional depending on the configuration thereof. In the forwards refresh, the frames received renew the link of the destination MAC of the frame forwarded to the output port. In the bidirectional refresh, the link of the source MAC address to the input port is also renewed.

### Clearing Paths

If the paths are not used by the frames linked to them (with tuples of transport ports and MAC addresses in the forwarding table) during a period of time greater than the persistence timer (cache) of the bridges, they automatically expire, clearing the memory of the ports linked to the path.

Likewise, when an established path is interrupted, due to a link or bridge failing, the addresses learnt in the bridges, which are linked in the forwarding table to the port connected to the failed link or bridge, are automatically cleared.

Similarly to the establishment, the TCP-Paths may be explicitly cleared by the terminals when they send a FIN segment in each direction to close the TCP connection. A terminal sends a FIN segment that is responded to by the destination terminal with an ACK segment. This FIN segment closes the TCP-Path connection in the direction of the sent FIN segment. Likewise, it takes place from the remote end when a FIN segment is emitted, responding with an ACK segment towards the remote end in order to close the connection in the remote-close direction. Alternatively, the receiving end may respond with a combined FIN+ACK segment (the so-called three-way TCP handshake), which is responded to with an ACK segment to confirm the close in the remote-close

direction. This ACK segment is not encapsulated. More specifically, when the edge bridge receives a TCP segment with the activated FIN indicator, it encapsulates the segment in a PathFlush packet with the same source and destination addresses as the segment received, which is forwarded in unicast towards the destination following the path established by CA, in order to thus clear the A towards C path linked to this TCP connection. The next bridge crossed, when it receives said unicast PathFlush frame with the protocol-type field, containing the value assigned to the “TCP-Path” protocol, it clears from the table, for the purposes of forwarding, the link of the destination MAC address and destination transport port to the port of the bridge and the content of the linked expiration timer, without modifying other links of said MAC address to other bridge ports; it likewise checks if the destination MAC address of the frame encapsulated within the PathFlush frame corresponds to a terminal connected directly to the bridge that receives the frame and, if this is the case, it de-encapsulates the frame and it is forwarded to the destination terminal by the port of the bridge linked to said terminal. If the destination MAC address of the encapsulated frame is not linked to a terminal connected directly to the bridge that receives the frame, the bridge forwards the PathFlush frame in unicast by the port linked to the recently cleared “TCP connection fields”.

### Forwarding Frames

When a data frame is received in a TCP-Path bridge, the TCP connection fields are consulted: source and destination MAC addresses, source and destination transport ports, and it is verified whether there is an existing port linked to said connection as a destination; if it exists, the frame is forwarded by the port linked to said connection towards the destination terminal and the timer linked to the destination MAC address and linked TCP-Path connection renewed for an additional period of time; if it does not exist, it is verified, in a less restrictive manner, whether there is a bridge port linked to the destination MAC address of the frame or to the destination MAC address and source MAC of the frame pair; in the other cases, the path repair process is initiated by sending a multicast frame. That is, when a specific TCP-path does not exist, the received frames may use another specific TCP-Path with the same destination MAC address as the destination or a generic path only linked to said MAC address (created by means of ARP-Path or Flow-Path). If there is no active generic path, one of the specific TCP-Paths shall become generic, linking it to the destination MAC address in order to be used by all the frames with this destination.

If there is no generic path, the generic path is repaired with the common ARP-Path or Flow-Path repair as described in [Elise Rojas, Guillermo Ibanez, Diego Rivera, Juan A. Carral, “Flow-path: An AllPath flow-based protocol”, Proceedings of the 2012 IEEE 37th Conference on Local Computer Networks (October 2012) pg. 244-247].

### Network Bridge for TCP-Path

The described mechanisms for establishing paths, clearing paths and forwarding frames may be implemented in a network bridge that is provided with the corresponding tables to link the ports to tuples formed by pairs of MAC addresses and source and destination transport ports.

### BRIEF DESCRIPTION OF THE DRAWINGS

FIG. 1 shows the flow diagram of the protocol to establish the paths for TCP flow.

FIG. 2 shows the previous establishment, in a network of TCP-Path switches, of ARP-Paths between two terminals A and C, linked to the MAC addresses of both, by means of the exchange of ARP Request and ARP Reply messages.

FIG. 3 shows the search of a TCP-Path after the receipt of a TCP transport segment with activated SYN (PathRequest).

FIG. 4 shows the confirmation of the path in the opposite direction with the TCP transport segment with activated SYN and ACK (Path Reply).

FIG. 5 shows the ACK segment (third phase of the three-way handshake) emitted by terminal A as a response to the SYN+ACK forwarded through the new established TCP-Path.

FIG. 6 shows a case in which no new additional TCP-Path is created in the network because the pre-existing generic ARP-Path is the fastest.

FIG. 7 shows a case in which a new additional TCP-Path is created that is completely separate from the pre-existing generic ARP-Path.

FIGS. 8 and 9 show the clearing of the paths with FIN segments (PathFlush).

FIG. 10 shows the network after the TCP-Paths have been cleared.

FIG. 11 shows the learning that is carried out in the routing tables of a bridge that has the TCP-Path functionality activated.

### EMBODIMENT

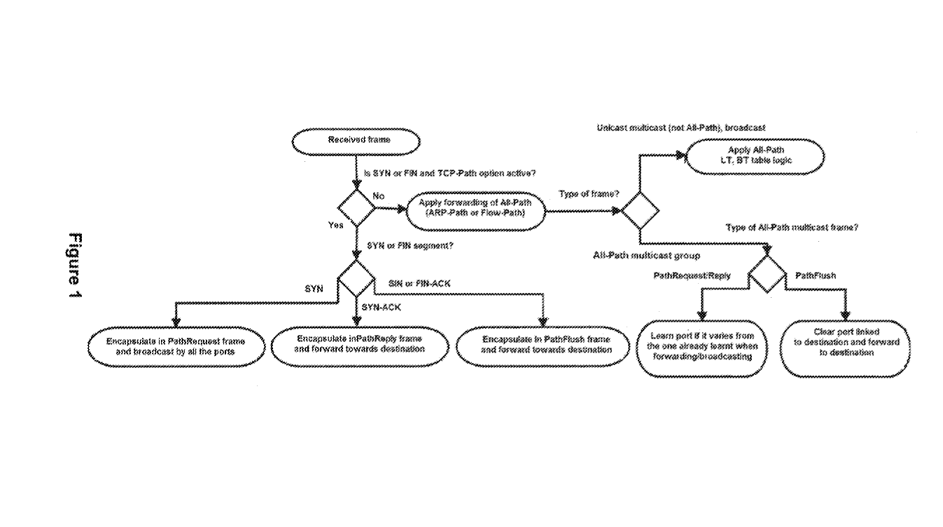

An embodiment of the invention is described. FIG. 1 shows the functional logic of the bridge for establishing paths in the form of a flow diagram. When a frame is received, the first thing to be checked is whether it is a transport segment with activated SYN or FIN flags, encapsulated in the corresponding PathRequest (SYN), PathReply (SYN+ACK) or PathFlush (FIN) packet if this is the case. If it is not the above-type segment, it is analysed whether it is a special All-Path (PathRequest, PathReply or PathFlush), in which case the path is learnt or cleared following the logic of the TCP-Path. Lastly, if it is not any of the above cases, the functionality logic of the ARP-Path and generic Flow-Path protocols is used.

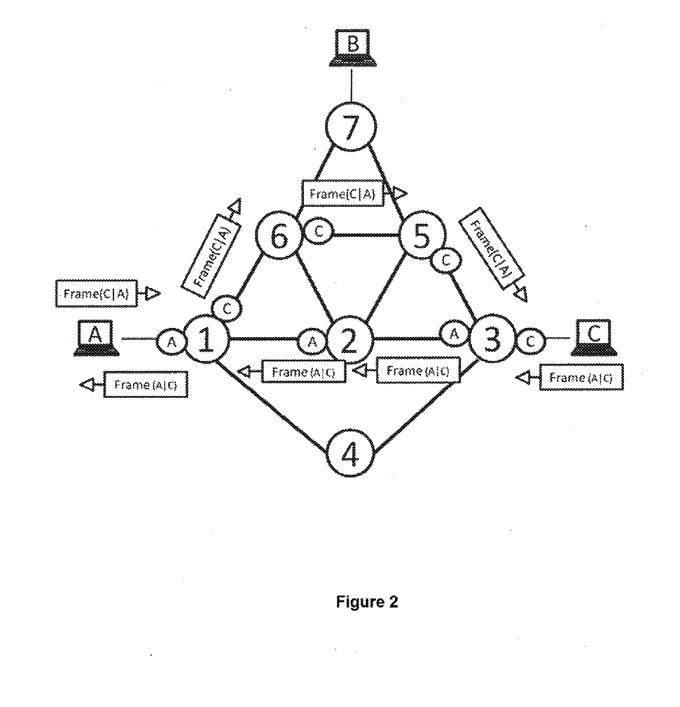

FIG. 2 shows an exemplary network to examine the learning, clearing and repairing mechanism of TCP-Path. Terminals A, B and C are connected to the edge bridges 1, 7 and 3 respectively. These bridges have established paths between them by means of the ARP-Path protocol, based on the learning of the source MAC address of the ARP Request and ARP Reply packets emitted by said terminals when they start to communicate. The port to which the address of said terminal (learnt address) is linked is indicated with a circle surrounding a letter next to each bridge. For example, the path towards A is established in certain ports of the bridges 3, 2 and 1, whilst the path towards C has been created on the bridges 1, 6, 5 and 3. The address of the frames is thus shown in the case of communication traffic between terminals A and C. The expiration timers of each tuple linked to the port are activated and valid whilst the time limit for clearing has not passed.

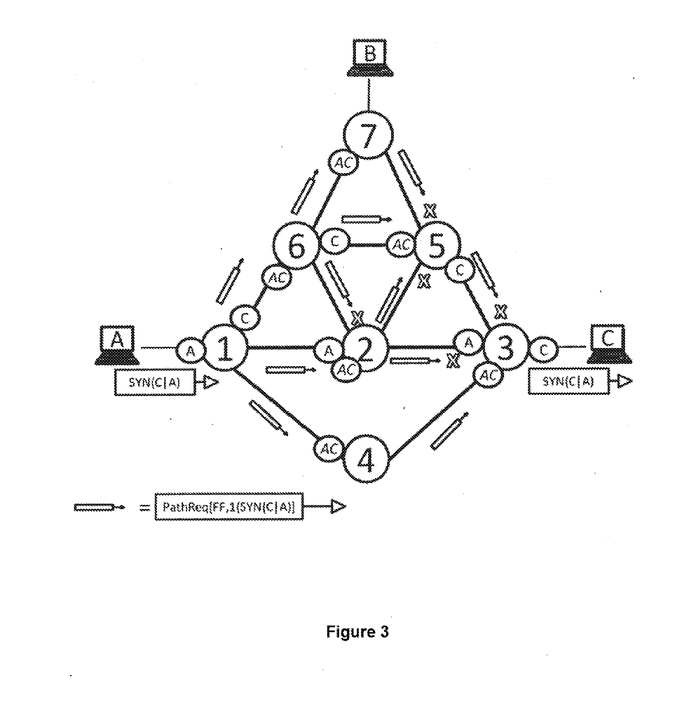

FIG. 3 shows the learning carried out when the first transport segment with active SYN flag is received from terminal A. The source of this segment is A and the destination is C. In the edge bridge 1 a PathRequest frame is encapsulated which is broadcast through the entire network. Thus, all the bridges receive a copy of the frame and note the tuple AC (path towards A) in one of its ports (except the bridge 1 that is the edge of terminal A), discarding the slow copies which are shown in the figure with an X. In this case, only the bridges 1, 2 and 3 have a prior path towards A, which means that the bridge 3 learns the tuple AC because it receives it through a different port than the current input for A, the port connected to the bridge 4, however the bridge 2 discards it as it has been receive by the same port as the current input for A, which is through the port through which it is connected to the bridge 1.

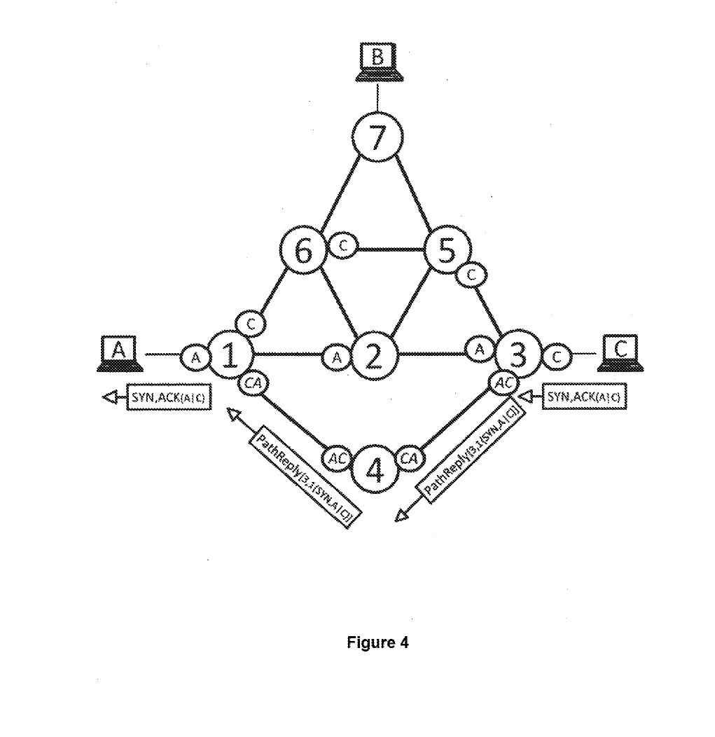

FIG. 4 then shows the behaviour when a transport segment with active SYN+ACK flags is received. In this case a segment of said type is received from terminal C (with response to the previous SYN that is directed from A to C) and it is the edge bridge 3 that is responsible for encapsulating it in a PathReply frame. This frame is forwarded by unicast by the port linked to the previously learnt tuple AC, i.e. it is routed through the bridges 3, 4 and 1. In the bridges 4 and 1, the tuple CA (path towards C) is learnt because there are no generic inputs previously linked to C and therefore it cannot coincide in the port with any of them.

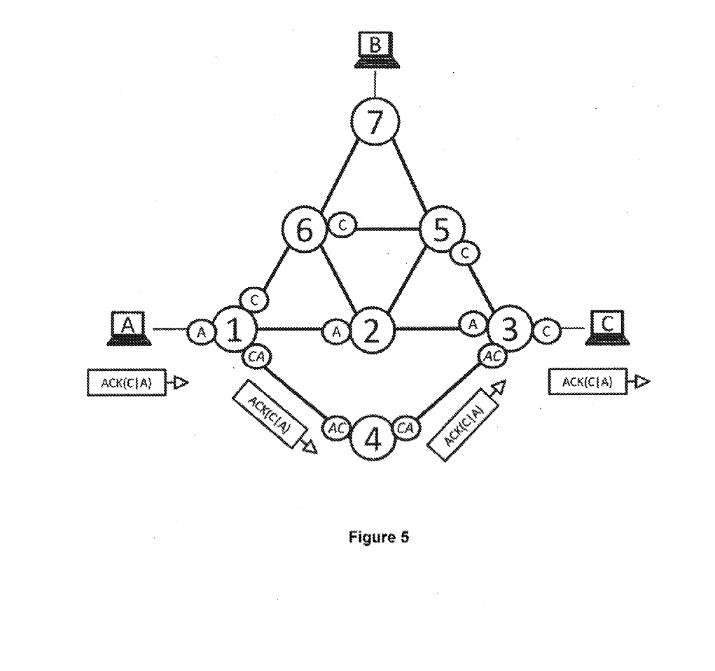

Lastly, the last part of the initiation of the TCP connection, which is a transport segment with the active ACK flag may be seen in FIG. 5. This final segment with source A and destination C does not have the active SYN flag, which means that the edge bridge 1 does not encapsulate it and treats it like any other traffic frame of said recently initiated connection, routing it through the ports linked to the tuple CA and passing through the bridges 1, 4 and 3 until it reaches C. Note that in the bridge 3 there is no input linked to the tuple CA due to being the edge bridge of C, for which reason the generic input C is used for routing, which is learnt in the first passage by the ARP-Path protocol.

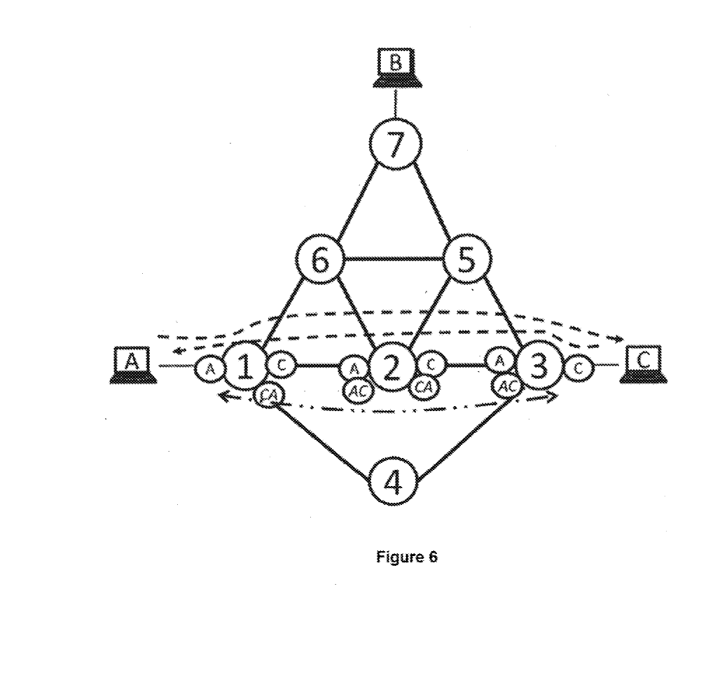

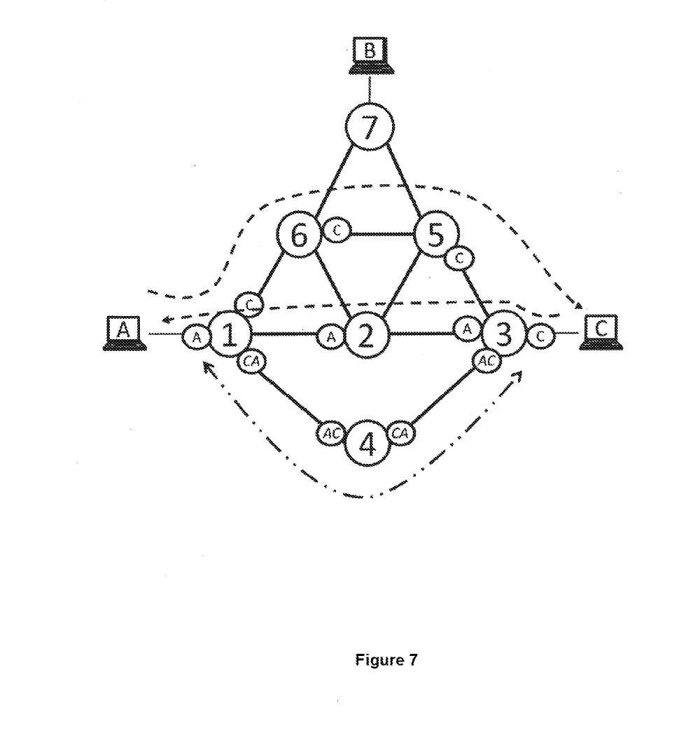

FIGS. 6 and 7 show two end cases of possible paths created by means of TCP-Path. In FIG. 6 the paths A and C created by ARP-Path coincide in direction, both crossing the bridges 1, 2 and 3, as well as the paths AC and CA also created by TCP-Path. What happens in this case in practice is that the tuple AC and CA are not noted, since they coincide with ports of the generic inputs A and C that already exist, which means that there is no alternative path. This is a situation that may arise in the event that the path 1, 2 and 3 continue to be the quickest path and is still not heavily used. In the case of FIG. 7, the opposite end is shown, that in which the generic ARP-Path A and C do not share bridges (expect the edge bridges 1 and 3), and the TCP-Path between A and C also crosses different bridges (crossing through the bridge 4). This last case may arise when all the paths are equally fast and are distributed equally throughout the entire network. Note that the TCP-Paths are symmetrical, which means that the tuples AC and CA always share bridges in one direction or the other (in this case 1, 4 and 3), whilst there is no reason for the generic ARP-Paths to do so.

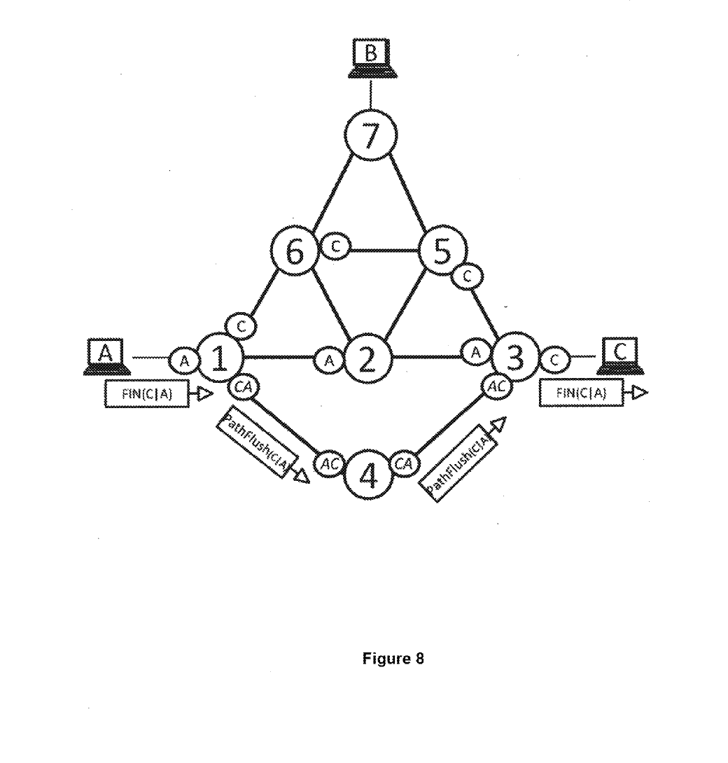

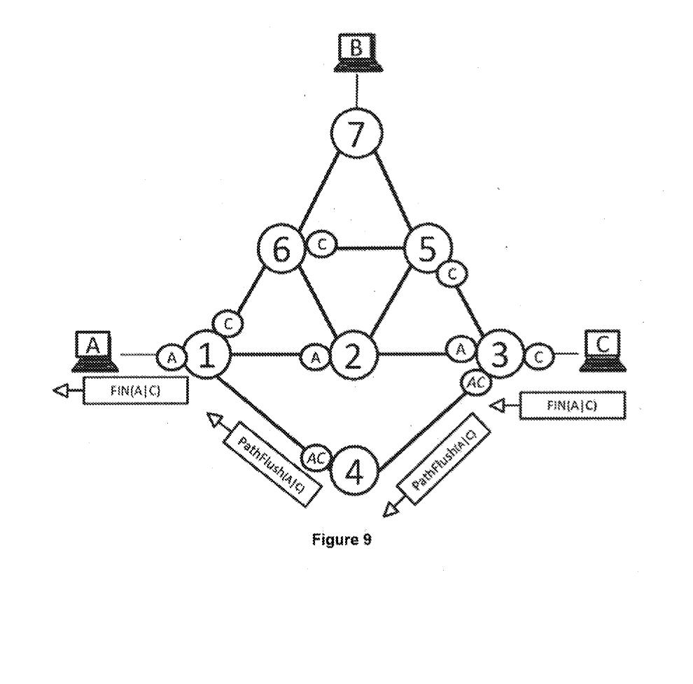

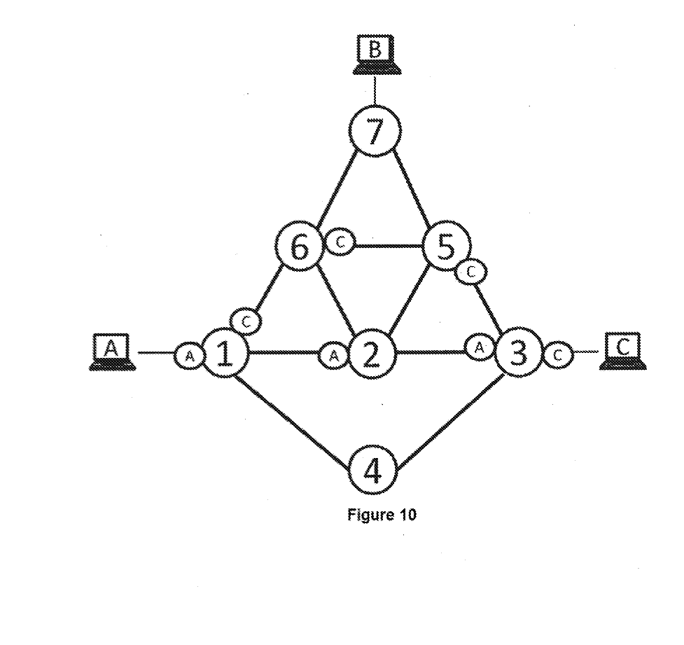

FIGS. 8, 9 and 10 show the clearing of the inputs AC and CA by means of All-Paths frames of the type PathFlush. This frame is created when transport segments that contain the active FIN flag (whether FIN or FIN+ACK) are encapsulated. In FIG. 8, a FIN segment is sent from terminal A to C, clearing the tuple CA, whilst in FIG. 9 the FIN segment goes from terminal C to A clearing the remaining tuple, AC. Lastly, FIG. 10 shows what the network would look like after the TCP-paths from the previous figures have been cleared using the PathFlush frame.

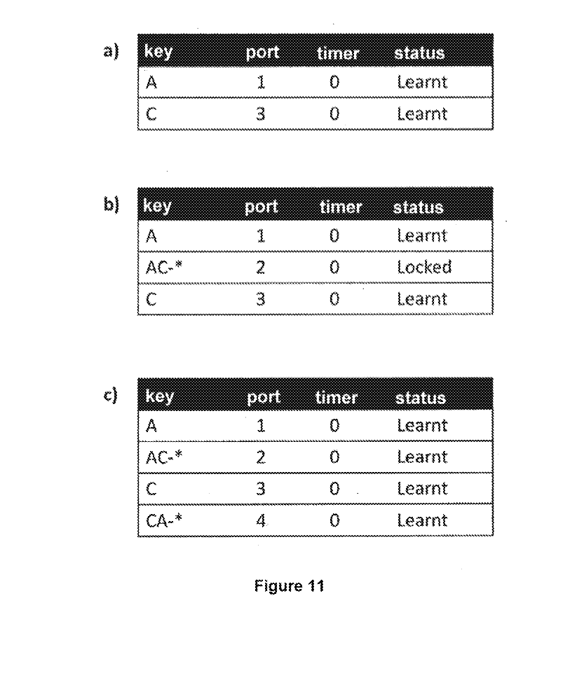

FIG. 11 shows what each circle (A, C, AC or CA) means, i.e. each one of the inputs in the table of the bridge that functions following the TCP-Path specification. FIG. 11.a) shows the inputs of an ARP-Path-type bridge after building a path between the hosts A and C. These inputs are made up of a search key (in this case, the MAC address), a linked port, a timer and a Locked or Learnt status. When a new PathRequest frame linked to a SYN message of the TCP protocol and with source A and destination C arrives, if the first copy arrives through a different port to the one already linked, TCP-Path learning takes place and its key is noted within the table as shown in 11.b) That is to say, the input with key A is the generic input to reach destination A, whilst AC-* is the specific key of the TCP-Path with destination A, but which is only used when the source is C and a set of parameters is met (specified with *) such as numbers of ports, etc. With the response of C towards A, SYN+ACK encapsulated in a PathReply message, if it arrives through a different port to the one already linked to C, analogue learning is carried out (FIG. 11.c).

Therefore, as well as the base path, additional paths are created with more specific keys, whilst the rest of the inputs of the table are analogue.

Furthermore, when a data frame with destination A arrives, two searches will now be carried out, one specific key search and another generic search if is not the first. But in turn, if the specific path did exist and it was cleared due to a connection failure, this guarantees that it will still be possible to use the base or generic path for routing.

1. A method for establishing paths, forwarding frames and clearing data frame paths comprising:
receiving, through a port of a network bridge where said port has an assigned port identity, a frame comprising a source MAC address and a destination broadcasting address;
linking, in a table, for the purposes of forwarding from the bridge, the source MAC address of the frame received to the identity of the port that first received the frame in said bridge, to an expiry indicator of said link and to the arrival time of the frame;
locking this link during a certain time, thus preventing said source address from being linked to another port of the bridge;
discarding the frames received through ports that are different to the one linked to the source address of the frame during the time in which this link is locked;
forwarding the unicast frames received by the port of the bridge that is linked to the destination MAC address of the frame;
clearing, in the table, for the purpose of forwarding, the address links that a port of a bridge may have when it detects the loss of a link in said port or the validity timer of the address expires;
requesting the repair of the path by means of a multicast frame when one frame with unicast destination reaches a bridge that does not have any port linked in the table, for the purpose of forwarding said MAC address,
characterised by
The existence of an establishment stage wherein, when a port of a network bridge with an identity assigned to each of the ports thereof receives a frame that transports a TCP segment that has the indicator for SYN connection request activated and the ACK indicator disactivated,
creating a new connection, assigning a unique internal identifier for TCP-Path connection and linking said identifier to the exact combination of the following fields contained in the frame that transports the TCP segment: source MAC address, destination MAC address of the frame that transports the TCP segments and source TCP transport ports and destination of the TCP segment header, hereinafter “TCP connection fields”,
linking, in a table, for the purposes of forwarding, the source MAC and source TCP port addresses, as well as the TCP-path connection identifier, to the identity of the port of the bridge that first received the frame, to an expiry indicator of the frame and to the arrival time of the frame;
encapsulating the frame containing the TCP segment within a special multicast PathRequest frame with the destination address being the multicast group address shared by “all the TCP-Path bridges” and with the source address being the MAC address of the bridge that encapsulates the frame,
The existence of a confirmation and renewal stage, wherein, when a network bridge receives a frame containing a TCP segment with the indicator for SYN connection request activated and the ACK indicator activated (segment SYN−ACK),
confirming and renewing the connection, in the table, for the purposes of forwarding, renewing during a specific period of time the validity of the link, which was previously created in the bridge when the PathRequest packet was received, of the aforementioned “TCP connection fields” of the frame received (source and destination MAC addresses and source TCP and destination TCP port identities) with the connection identifier, with the identity of the port of the bridge that first received the frame, with an expiry indicator of the frame and with the arrival time of the frame;
encapsulating the frame containing the TCP SYN−ACK segment within a special unicast PathReply frame with the source address being the bridge that encapsulates it and the destination being the MAC address of the bridge that was linked in the bridge to said connection after the receipt of the PathRequest for said connection,
The existence of a clearing stage, wherein, when a frame containing a TCP segment with the indicator for FIN connection request activated is received in a network bridge;
encapsulating the TCP segment within a special unicast PathFlush frame directed at the destination edge bridge by the port linked to the address of the destination terminal, with the protocol type field, Ethertype, with the value assigned to “TCP-Path”;
clearing, from the table, for the purposes of forwarding, the link of the “TCP connection fields” linked to the destination and the contents of the linked timers.
When a frame not included in the above cases is received in a network bridge:
verifying whether it belongs to an existing connection in the bridge, checking the TCP connection fields: source and destination MAC addresses, source and destination transport ports;
if this is the case: forwarding the frame through the port associated to said connection towards the destination terminal and renewing the timer linked to the destination MAC address;
in the other cases: if there is a specific TCP-Path linked to the destination MAC address but linked to a port of the bridge that is different to the failed port, forwarding said frame through said output port,
in the other cases: checking whether there is a port of the bridge linked to the destination MAC address of the frame:
if so: forwarding the frame through said port;
in the other cases: sending a multicast frame to initiate the path repair mechanism.

2. The method according to claim 1, characterised by, in the establishing stage, when a multicast PathRequest frame directed to the multicast group address “all the TCP-Path bridge” and protocol type, field in the frame usually known as Ethertype, with the value of “TCP-Path” is received in a network bridge;
linking, in a table, for the purposes of forwarding, the source and destination MAC addresses and source and destination transport port identities of the original frame encapsulated within the frame received (“TCP connection fields) to the identity of the port of the bridge that first received the frame, to an expiry indicator of the frame and to the arrival time of the frame;
linking, in a table, for the purposes of forwarding, the source MAC address of the PathRequest frame to the identity of the port of the bridge that first received the frame;
checking whether the destination MAC address of the frame encapsulated within the PathRequest frame corresponds to a terminal connected directly to the bridge that receives the frame;
if so: de-encapsulating the frame and forwarding it to the destination terminal through the port of the bridge linked to said terminal;
in the other cases: forwarding the frame through all the ports except the port where it was first received;
putting it in the output queue of the ports of the bridge according to previously configured priority criteria.

3. The method, according to claim 1, characterised by, in the confirmation and renewal stage, when a unicast PathReply frame with destination being a bridge MAC address and with the protocol type, field in the frame usually known as Ethertype, containing the value linked to “TCP-Path” is received;
linking, in a table, for the purposes of forwarding, the source and destination MAC addresses and source and destination transport port identities of the original frame encapsulated within the frame received (“TCP connection fields) to the identity of the port of the bridge that first received the frame, to an expiry indicator of the frame and to the arrival time of the frame;
checking whether the destination MAC address of the outer encapsulation of the frame corresponds to the bridge that is processing the frame;
if so: de-encapsulating the frame and forwarding it to the destination terminal through the port of the bridge linked to said terminal;
in the other cases: forwarding the frame through the port linked to the source and destination MAC addresses and source and destination transport ports of the TCP-Path connection and renewing the link of the “TCP connection fields” to the forwarding port.

4. The method according to claim 1, characterised by, in the clearing stage, when a unicast PathFlush frame with the protocol type field, Ethertype, with the value “TCP-Path” value assigned to the protocol is received in a network bridge;
clearing, from the table, for the purposes of forwarding, the link of the “TCP connection fields” linked to the destination and the content of the linked timers, without modifying other links of said MAC addresses to ports of the bridge that are not linked to the indicated source and destination ports;
checking whether the destination MAC address of the frame encapsulated within the PathFlush frame corresponds to a terminal connected directly to the bridge that receives the frame;
if so: de-encapsulating the frame and forwarding it to the destination terminal through the port of the bridge linked to said terminal;
in the other cases: forwarding the PathFlush frame in unicast through the port linked to the recently cleared “TCP connection fields”.

5. A network bridge characterised in that it has processing means suitable for implementing the method of claim 1.

6. A switched telecommunications network characterised by comprising at least one network bridge defined according to claim 5.
